(19) United States
(12) Patent Application Publication
(10) Pub. No.: US 2026/0195161 A1
(43) Pub. Date: Jul. 9, 2026

(54) RECOVERY OF CONTAINERS HAVING IMAGE LAYERS WITH INTER-LAYER DEPENDENCIES

(71) Applicant: INTERNATIONAL BUSINESS MACHINES CORPORATION, Armonk, NY (US)

(72) Inventors: Xiao Ling Chen, Beijing (CN); Heng Wang, Beijing (CN); Ying Mo, San Jose, CA (US); Hao Wu, Beijing (CN)

(21) Appl. No.: 19/014,921

(22) Filed: Jan. 9, 2025

(51) Int. Cl. G06F 9/455

(52) U.S. Cl. CPC G06F 9/45558; G06F 2009/45591

(57) ABSTRACT

An image layer of a container image deployed as a container on a local resource is identified as having a patch in error. The image layer is marked, at an image repository, as having the patch in error. It is determined that one or more image layers of the container have a dependency on the image layer having the patch in error. The one or more image layers that have the dependency are indicated at the image repository. Recovery of the container is initiated, and the recovery is based on at least one of the marking or the indicating. To recover the container, selected image layers are to be pulled from the image repository. The image layer marked as having the patch in error and the one or more image layers indicated as having the dependency on the image layer are to be omitted from being pulled.

### BACKGROUND

One or more aspects relate, in general, to a computing environment that uses containers, and in particular, to recovery processing of containers.

Containers provide an application layer approach to virtualization. A container packages together code and its dependencies, and the container can be run on a physical processing system. Multiple containers can be run on the same physical processing system. This approach uses less resources than a virtual machine approach to virtualization.

A container includes one or more image layers (also referred to herein as layers). Each layer represents a modification to the file system that is within the container. Example modifications include adding a new file or modifying an existing file. When a layer is created, it becomes immutable, and thus, cannot be changed.

### SUMMARY

Shortcomings of the prior art are overcome, and additional advantages are provided through the provision of a method. The method includes identifying an image layer of a container image deployed as a container on a local resource as having a patch in error. The image layer is marked, at an image repository, as having the patch in error. It is determined that one or more image layers of the container have a dependency on the image layer having the patch in error. The one or more image layers that have the dependency on the image layer having the patch in error are indicated at the image repository. Recovery of the container is initiated, and recovery of the container is based on at least one of the marking or the indicating. To recover the container, selected image layers are to be pulled from the image repository. The image layer marked as having the patch in error and the one or more image layers indicated as having the dependency on the image layer having the patch in error are to be omitted from being pulled.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIGS. 2A-2B depict example recovery techniques for a container image layer having an error, in accordance with one or more aspects of the present disclosure;

FIG. 3 depicts one example of an inter-layer dependency among image layers of a container, in accordance with one or more aspects of the present disclosure;

FIG. 4 depicts one example of an architecture to incorporate and implement one or more aspects of the present disclosure;

FIG. 5 depicts further details of one example of an architecture to incorporate and implement one or more aspects of the present disclosure;

FIG. 6 depicts one example of using a patch in error manifest inter-layer dependency healthy updater module to facilitate recovery of a container, in accordance with one or more aspects of the present disclosure;

FIG. 7 depicts one example of using a patch in error layer recovery on inter-layer dependency module to facilitate recovery of a container, in accordance with one or more aspects of the present disclosure;

FIG. 8 depicts one example of the container layer recovery code of FIG. 1, in accordance with one or more aspects of the present disclosure;

FIG. 9 depicts one example of a patch in error manifest inter-layer dependency healthy updater process, in accordance with one or more aspects of the present disclosure; and

FIG. 10 depicts one example of a patch in error layer recovery on inter-layer dependency process, in accordance with one or more aspects of the present disclosure.

### DETAILED DESCRIPTION

In one or more aspects, a capability is provided to recover a container in which an image layer of the container has an error (referred to herein as a layer in error or patch in error). The recovery is based on one or more inter-layer dependencies with one or more other image layers of the container. In one or more aspects, the container having the patch in error is recovered more precisely based on the inter-layer dependencies.

In one or more aspects, a technique transparent to developers and end users of the image is provided that is intelligent and automatic, ensuring better use of product capabilities, automation and resiliency insights. In one or more aspects, the technique includes updating within a repository a manifest configuration item of the layer in error and/or other layers with a selected attribute (e.g., a ManInterLayerDependencyHealthy attribute), and then pulling layers without patches in error or without a hazardous inter-layer dependency, as indicated by the attribute, e.g., the ManInterLayerDependencyHealthy attribute. This facilitates users in promoting the robustness of the enterprise-level production environment, as soon as possible, and avoiding security vulnerability exposure, as much as possible.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of recovering containers having image layers in error that have inter-layer dependences and/or performing one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

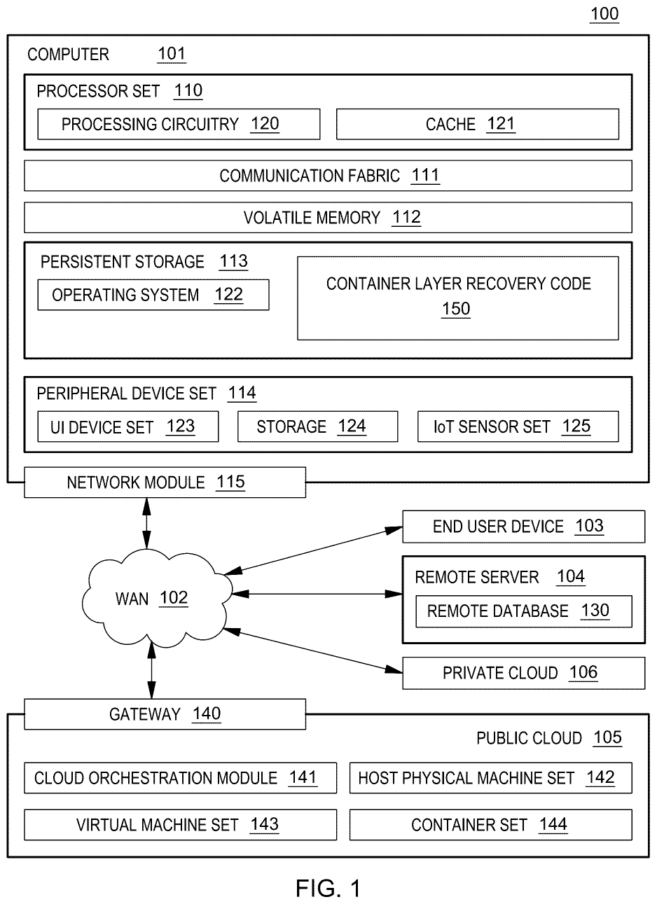

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as container layer recovery code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

A container packages together code and its dependencies to provide for virtualization. Some approaches to implementing containers involve packaging the contents of image layers into an image and pushing the image to an image repository. The image can then be pulled from the image repository, such as by end users, to be implemented on other systems. When pulling an image from the image repository, the contents of the image layers and any parent layers for the image are downloaded to a local resource. One example of a local resource is a local graph (also referred to as a local graph node), which is a structure used for managing and visualizing dependencies, relationships, and/or states of containers and services within a local environment (e.g., a user's production environment). The local graph is managed by a container management process (e.g., a container daemon and/or other container management processes), and a command line interface (CLI) can be used to interact with the local graph. For example, the command line interface can be used to list images, create containers, remove containers and images, inspect images and containers, and more. Once downloaded, the image can be stored on a local graph and deployed as a container. In other words, the layers of the image are uploaded to the image repository and then those layers are later downloaded to one or more local graphs for deployment as a container.

In some cases, patches may be released to fix errors or add functionality to an image. For example, after an image is released (e.g., uploaded to the image repository), an error may be identified in the image, and a patch may be released to address the error. In such cases, a patch itself may have an error, which is referred to as a patch in error. For example, to fix an issue identified in an older layer (e.g., layer 3 (L3)) of an image, a fix patch can be delivered on a newer layer (e.g., layer 5 (L5)) of the image. It may be discovered thereafter that the fixes on the newer layer (e.g., L5) trigger other errors, thus the original patch is a patch in error.

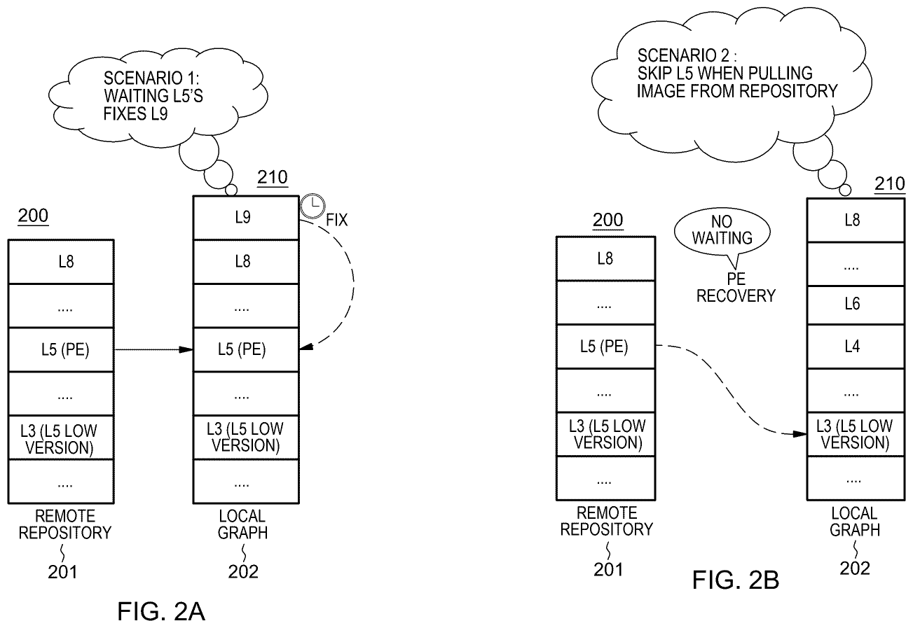

Often a user is not to remove (or cannot remove) the patch in error immediately, if, e.g., a higher version layer dependent on the layer with the patch in error is used in the user's production environment. If a higher version layer (e.g., layer 7 (L7) or another layer) is exploited on a user's production environment, the user is not to remove (or cannot remove) the patch in error (e.g., layer 5 (L5)), which the higher version layer depends. For instance, a top layer (or other layer) of a user's environment is layer 8 (L8) and another layer, e.g., layer 5 (L5), includes the patch in error and is followed by layers 6 and 7 (L6 and L7), which are between the patch in error and the top layer. In such cases, there are options for the user: wait for the availability of L5 fixes (which may take several months to receive, for example) or redeploy a lower safe version (e.g., the version for layer 4 (L4) or other layer lower than L5). These situations are further described with reference to FIGS. 2A-2B.

Referring to FIGS. 2A and 2B, in one example, a container image 200 and a container 210, each with layers, are shown, according to an embodiment. The container image 200 is stored in an image repository, such as a remote repository 201 (e.g., in storage 124, persistent storage 113, remote server 104, public cloud 105, etc.) and can be downloaded to and installed on a local graph 202 as container 210. A container image (e.g., container image 200) is a standalone executable software package that includes the information used to run a piece of software, including the code, runtime, system tools, libraries, and settings. Container images are used to create containers, which are instances of the container images running as isolated processing on a host operating system (e.g., operating system 122). For example, container image 200 is used to create container 210. According to an embodiment, container 210 in FIGS. 2A and 2B is a container image pulled from image repository 201 to a local graph 202.

According to another embodiment, a container process mounts layers (e.g., a base layer, layer L1, . . . Layer L7, Layer L8, etc.) at one mount point. These are called image layers, and container 210 exploited with this image can share the image layers (e.g., read-only layers) and have their own container layer (read-write layer). For example, the container process runs three containers C1, C2, C3 with image I1, then containers C1, C2, C3 share the image layer of I1, which is stored in local graph 202 as container 210 shown.

In FIG. 2A, container image 200 and container 210 are shown as having multiple layers, including layers L3, L5, and L8, among others. In FIG. 2B, container image 200 and container 210 are also shown as having multiple layers, including layers L3, L4, L5, L6, and L8, among others.

If a patch in error (PE) is deployed to one of the layers (e.g., to layer L5 as shown in FIG. 2A), it may take time for a new fix to be implemented as a new layer of container 210 of FIG. 2A (e.g., layer L9). In some cases, the new layer (e.g., layer L9) may take weeks or even months to be implemented, thus causing container 210 to function improperly (e.g., using the patch in error at layer L5) until the fix is implemented.

As shown in FIG. 2B, rather than waiting for a new layer (e.g., layer L9) to be implemented to fix the issue(s) identified in an older layer (e.g., layer L5), it is possible to perform patch in error recovery to recover the layers of container 210 with the patch in error (e.g., layer L5) being skipped. In one example, this may be performed quickly based on a real-time patch health status, such as a ManPatchHealthStatus (herein Man stands for manifest) and/or other statuses and/or attributes, updated into a manifest list of an image repository. A single manifest includes information about an image, such as its size, layers and digest. A manifest list is a list of image layers (e.g., manifests or manifest items) that are created by specifying one or more image names. The updated ManPatchHealthStatus and/or other attributes provide for rolling back the layer of the container having the patch in error (e.g., layer L5) to a parent image layer (e.g., layer L4) or other layer lower than L5. Other examples are possible.

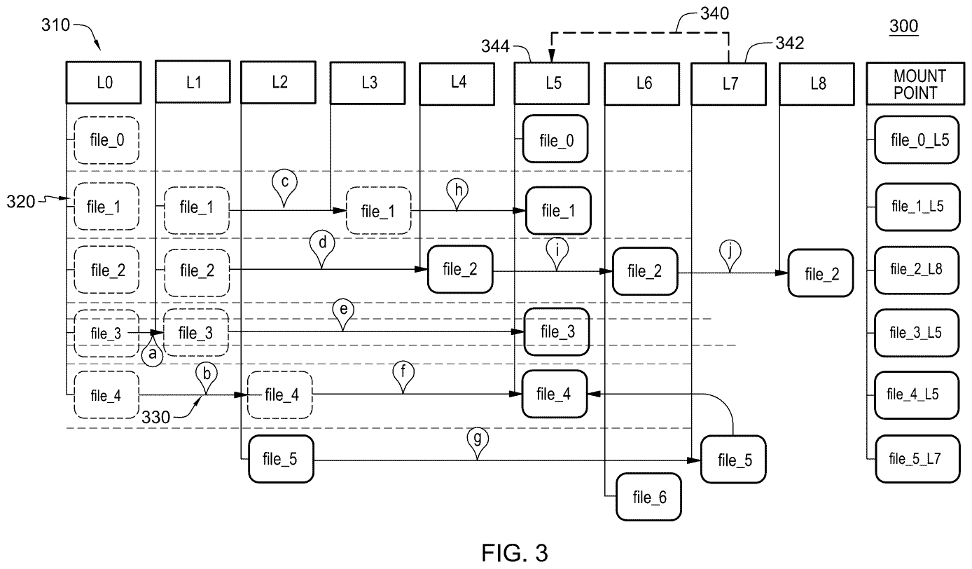

In one or more embodiments, one layer of a container may have a dependency on one or more other layers of a container. For instance, as depicted in FIG. 3, a container 300 includes a plurality of layers 310 (e.g., layers L0-L8), and each layer 310 includes one or more files 320. There are dependencies between one or more layer files, as depicted in layer file dependent sequences 330 (lines with arrows marked by letters). In one example, there is an inter-layer dependency relationship 340 between layer 7 (L7 342) and layer 5 (L5 344). For example, a file of layer L7, e.g., file_5_L7, is dependent on a file of layer L5, e.g., file_4_L5, which, in one example, is a dynamic library. In this example, if L5, which is marked as the layer with the patch in error is skipped when pulling the image layers from the repository, then, due to the interdependency, L7 will work unexpectedly, since file_4_L5 is unavailable. This is addressed herein, in accordance with one or more aspects.

As indicated, current container technology packages the contents of image layers and pushes them to a repository in the form of an image. When pulling an image from the repository, the entire contents of the specified image layers and parent layers are downloaded to the local environment. This process of uploading or downloading layers of the image can be inefficient and time-consuming.

After the release of a product, continuous delivery of patches is performed for service work. If a patch previously released (e.g., months or another time period earlier) is found to be in error, users do not immediately remove the erroneous patch if a higher version layer is used in their production environment. For instance, if an issue is found on an old layer and a fix patch is delivered on a newer layer, and later the fix patch triggers other errors, users face significant challenges. In such cases, users either wait for the availability of fixes for the erroneous patch or redeploy a lower safe version, potentially abandoning new functions or fixes on higher layers.

However, in accordance with one or more aspects, an intelligent and automatic capability is provided to ensure better use of product capabilities, automation, and resiliency insights by recovering the patches in error more precisely based on inter-layer dependencies locally in the container environment. In one or more aspects, the layer's manifest configuration item on the repository is updated with an attribute, e.g., ManInterLayerDependencyHealthy, and then the layers without patches in error or without a hazardous inter-layer dependency on the layer with the patch in error are pulled, to help users promote the robustness of the enterprise-level production environments, as soon as possible, and avoid security vulnerability exposure, as much as possible

In one or more aspects, this capability allows users to recover the patches in error more precisely based on inter-layer dependencies and with as little as possible risk. The capability is transparent to both the developers of the image and the end users, in one example.

In one or more aspects, layers in error are handled by automatically resolving layer dependencies to ensure that the entire local container system works as expected and with more precision. It facilitates users promoting the robustness of the enterprise-level production environments, as soon as possible, and avoids or limits security vulnerability exposure.

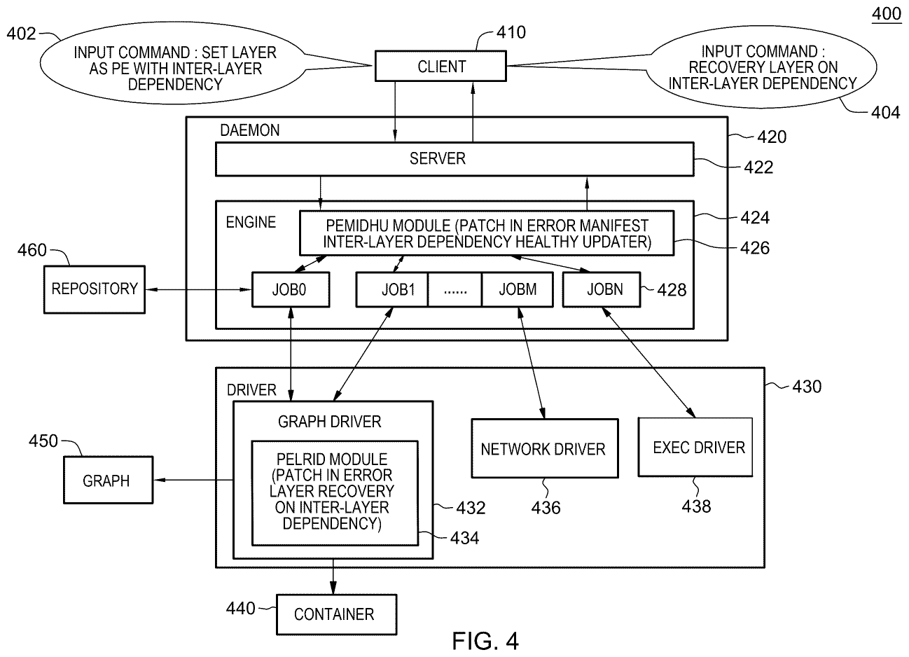

FIG. 4 illustrates one example of a system diagram of a system 400 having an architecture with, for instance, a patch in error manifest inter-layer dependency healthy updater (PEMIDHU) module (e.g., code implemented in hardware and/or software) 426 and a patch in error layer recovery on inter-layer dependency (PELRID) module (e.g., code implemented in hardware and/or software) 434 used to facilitate recovery of containers that have patches in error and inter-layer dependencies on the layers with the patches in error. System 400 includes, for instance, a client 410; a daemon 420 having a server 422 and an engine 424, such as a container recovery engine, that includes patch in error manifest inter-layer dependency healthy updater module 426; one or more drivers 430; and a container 440.

In one example, client 410 issues a set layer command 402 (e.g., set layer as patch in error with inter-layer dependency command) and/or a recovery layer command 404 (e.g., recovery layer on inter-layer dependency command) to server 422 of daemon 420. In one example, set layer command 402 is used to invoke a module (e.g., patch in error manifest inter-layer dependency healthy updater module 426) to perform marking, at an image repository (e.g., repository 460), of an image layer as the image layer having a patch in error and/or indicating, at the image repository, that one or more image layers have a dependency on the image layer having the patch in error. As an example, when set layer command 402 is received, engine 424 that executes module 426 is invoked to update, e.g., one or more attributes of the layer's manifest configuration, ManInterLayerDependencyHealthy. This engine is responsible for handling the recovery of image layers with patches in error and inter-layer dependencies.

Similarly, recovery layer command 404 is used to initiate recovery of the container, and recovery of the container is based, for instance, on the marking of the image layer as having the patch in error and/or the indicating that one or more image layers have a dependency on the image layer having the patch in error. In one example, when recovery layer command 404 is received, engine 424 is invoked to, at least, initiate recovery of the container having the layer with the patch in error more precisely based on inter-layer dependencies.

Engine 424 interacts, in one example, with various jobs 428 (e.g., Job0, Job1, . . . , JobM, JobN), which manage the execution of tasks related to the recovery process. These jobs communicate with, e.g., driver 430, which includes a graph driver 432, a network driver 436, and an execution (exec) driver 438, as examples. Graph driver 432 is responsible for managing a local graph 450, where the container image is deployed as a container (e.g., container 440) and includes, e.g., patch in error layer recovery on inter-layer dependency module 434 used in recovering the container. Network driver 436 and execution driver 438 handle network and execution-related tasks, respectively.

System 400 includes a repository 460, from which the container image is downloaded, and deployed and managed on local graph 450 as a container (e.g., container 440). That is, container 440 represents the deployed container running in the local environment. In one example, repository 460 is coupled to a recovery engine (e.g., engine 424), and thus, to module 426 executing on the engine. Further, in one example, graph 450 (an example of a local resource) is coupled to driver 430, and thus, to e.g., graph driver 432 and module 434 executing on the graph driver.

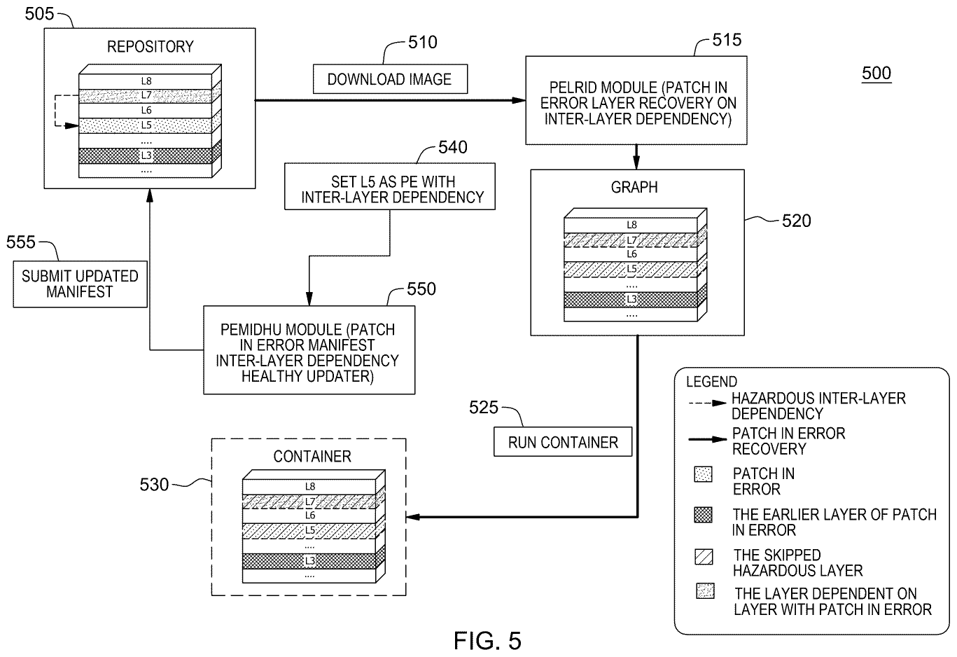

FIG. 5 illustrates one example of a process flow 500 for downloading 510 an image from a repository 505 to a local graph 520 running 525 a container 530. The container image has multiple layers, including, at least, L3, L5 (with a patch in error), and L8, as examples. The container image is downloaded to local graph 520, which is a structure used for managing and visualizing dependencies, relationships, and states of containers and services within a local environment. The downloaded container image is deployed as container 530 at local graph 520. Container 530, prior to recovery, includes the same layers as the downloaded image: including, at least, L3, L5 (with a patch in error), and L8, as examples. Local graph 520 manages the container and its layers, allowing for efficient deployment and management of the container image.

Once the container is running, the image layer with the patch in error (L5) is identified, in one example. For instance, a signal or notification is received that layer L5 has a patch in error and/or the system determines, based on one or more criteria, that the patch is in error. Other examples are possible. Based on identifying the patch in error, recovery of the container is performed and that recovery takes into consideration any inter-layer dependencies of other layers with layer L5, in accordance with one or more aspects.

In one example, a user inputs commands to recover the container having the image layer with the patch in error. As examples, commands, such as set layer as patch in error with inter-layer dependency command (also referred to herein as a set layer command) and recovery layer on inter-layer dependency command (also referred to as a recovery layer command) are used to recover the container with the image layer having a patch in error. In one example, the set layer as patch in error with inter-layer dependency command is used 540 to invoke, e.g., a patch in error manifest inter-layer dependency healthy updater module (e.g., patch in error manifest inter-layer dependency healthy updater module 550) to perform marking the image layer having the patch in error as the image layer having the patch in error and/or indicating that one or more image layers have a dependency on the image layer having the patch in error. This command allows the system to handle the patch in error without, for instance, restarting the service running the container.

In one example, process 500 issues 540 the set layer as patch in error with inter-layer dependency command, which invokes, e.g., patch in error manifest inter-layer dependency healthy updater module 550 (also referred to as module 550). Module 550 performs processing to mark the patch in error, update one or more manifest attributes based on the patch in error and inter-layer dependencies, and submit 555 an updated manifest to repository 505 (which is coupled, in one example, to a recovery engine, e.g., engine 424, executing module 550). Further, in one example, patch in error layer recovery on inter-layer dependency module 515 is triggered by, e.g., the recovery layer on inter-layer dependency command based on the set layer command setting the layer as a patch in error. For instance, the recovery layer command is used to initiate recovery of the container. Based thereon, a recovery module (e.g., patch in error layer recovery on inter-layer dependency module 515) executing on a driver (e.g., graph driver 432) coupled to a local resource (e.g., graph 520) is used to recover the container based on the marking and/or the indicating. In this case, when the container is downloaded, any image layers that are indicated as having a patch in error or dependent thereon are not downloaded. Instead, they are omitted from the downloading or the pulling of image layers.

Further details regarding the indications of whether a layer may be included as part of the download for the container or are omitted are described below.

In one example, an attribute, e.g., ManInterLayerDependencyHealthy, is introduced to the manifest layers and it includes two status types:
[Depender's Digest, Hazardous inter-layer dependency] used to describe the dangerous inter-layer dependency between a dependent layer (e.g., L7 (Dependee) in this example) and a layer with a patch in error (e.g., L5 (Depender), in this example), since L5 is the layer marked as patch in error. Other examples are possible.

In one example:

L7 Manifest:

```
{
  ......
  ″ManPatchHealthStatus″: normalPatch
  ″Digest″: ″sha256:3fl9f....rv3v″,
  “ManInterLayerDependencyHealthy”: [sha256:vfv45....c2ft,
        Hazardous inter-layer dependency]
  ″SchemaV2Manifest″: {
    ...
    ″layers″: [
          {
            ...
            ″digest″: ″ sha256:eab8c....d3da”
      ....
}
```

Another status type is: [Depender's Digest, Secure inter-layer dependency] used to describe the safe inter-layer dependency between a layer (e.g., L8 (Dependee), in this example) and another layer (e.g., L6 (Depender), in this example), since L6 is a reliable layer. Other examples are possible.

In one example:

L8 Manifest:

```
{
  ......
  ″manPatchHealthStatus″: normalPatch
  ″Digest″: “sha256:uu123....78iy”,
  “ManInterLayerDependencyHealthy”: [sha256:eab8c....d3da,
        Secure inter-layer dependency]
  ″SchemaV2Manifest″: {
    ...
    ″layers″: [
          {
            ″digest″: ″ sha256:3fl9f....rv3v”
      ....
}
```

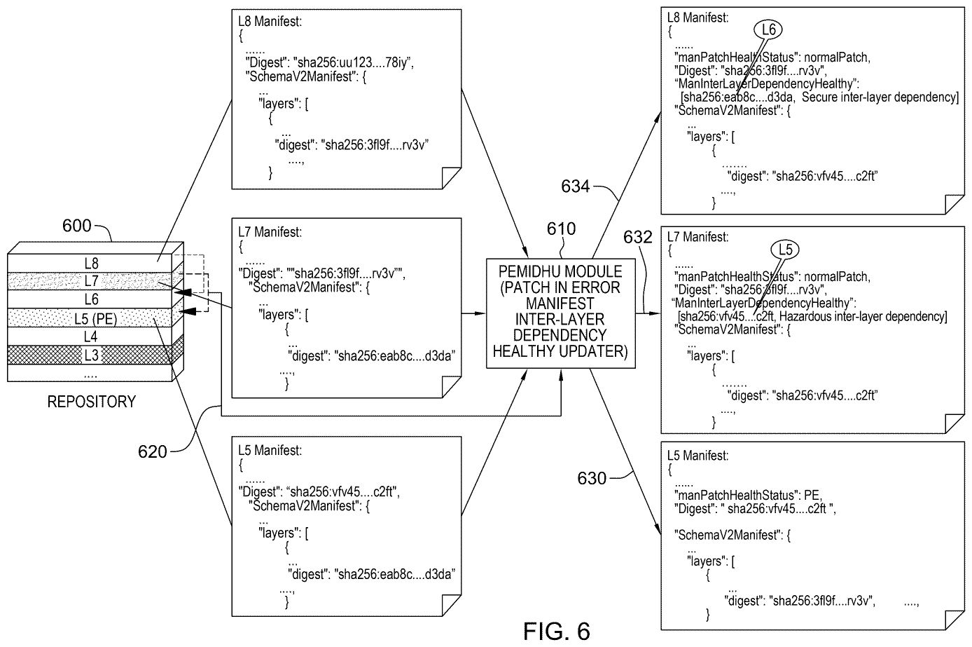

Further implementation details with respect to an example patch in error manifest inter-layer dependency healthy updater module is described with reference to FIG. 6. The patch in error manifest inter-layer dependency healthy updater module is used to update the attributes of the layer's manifest configuration, e.g., ManInterLayerDependencyHealthy, then push the updated manifest configuration to the repository. In one example, it is triggered by the set layer as patch in error with inter-layer dependency command. Other examples are possible.

In one example, a top image layer for an image stored in a repository 600 is image layer L8. Layer L5 of the image is identified as a patch in error (PE); L5 is the fix of another layer of the image, L3, in this example. A patch in error manifest inter-layer dependency healthy updater module (e.g., patch in error manifest inter-layer dependency healthy updater module 610) is triggered by issuing a command, such as the set layer as patch in error with inter-layer dependency command, to mark L5 as a patch in error. Further, in one example, it is determined that layer L7, as an example, has an inter-layer dependency on L5, and L8 has an inter-layer dependency on L6. A manifest attribute for L5 is updated 630 as follows, in one example: ManPatchHealthStatus=PatchInError(PE). A manifest attribute for L7 is updated 632 as follows, in one example: ManInterLayerDependencyHealthy: [sha256:vfv45 . . . c2ft, Hazardous inter-layer dependency]. In this example, sha256:vfv45 . . . c2ft is the L5_Digest. A manifest attribute for L8 is updated 634 as follows, in one example: ManInterLayerDependencyHealthy: [sha256:eab8c . . . d3da, Secure Inter-layer dependency]. In this example, sha256:eab8c . . . d3da is the L6_Digest. The updated manifests for L5, L7 and L8 are pushed 620 to the repository (e.g., repository 600). Other examples are possible.

Based on updating the manifest configuration, the container including the layer with the patch in error may be recovered based on the inter-layer dependencies. Such recovery is invoked by, e.g., executing the recovery layer on inter-layer dependency command which invokes the patch in error layer recovery on inter-layer dependency module, in one example.

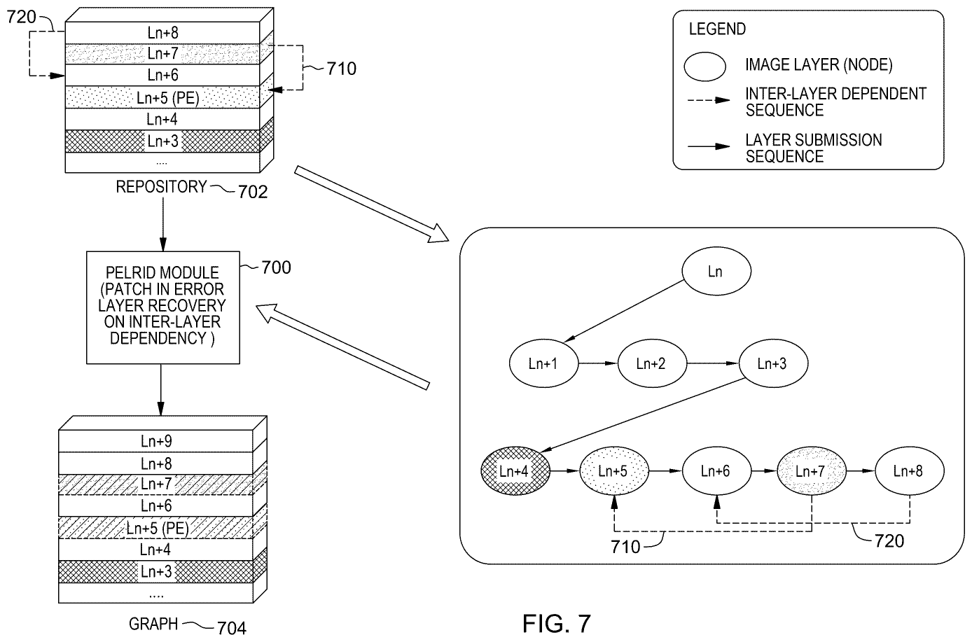

Further details regarding a patch in error layer recovery on inter-layer dependency module are described with reference to FIG. 7. In one example, a patch in error layer recovery on inter-layer dependency module (e.g., patch in error layer recovery on inter-layer dependency module 700) is used to pull selected images from a repository 702 to a local resource, such as a graph 704, while omitting certain layers.

In one example, referring to FIG. 7, Ln+7 (shown in a layer submission sequence) has a hazardous inter-layer dependency 710 on layer Ln+5 (marked with PE) and layer Ln+8 has a secure inter-layer dependency 720 on layer Ln+6. Patch in error layer recovery on dependency module (e.g., module 700) is triggered by a command, such as a recovery layer on inter-layer dependency command to recover the container having the layer with patch in error more precisely based on inter-layer dependencies by pulling only the layers not marked with patch in error or without hazardous inter-layer dependency on the layer with patch in error.

To further explain, processing of the patch in error layer recovery on inter-layer dependency module 700 includes obtaining from the repository the manifest configuration of, e.g., the top layer of the repository (e.g., layer 8), which is considered the target layer. Processing of module 700 determines whether there is a manifest item attribute ManPatchHealthStatus and whether its value, assuming there is such an attribute, is a patch in error. If yes, the target layer is skipped, else processing continues with a determination of whether the attribute ManInterLayerDependencyHealthy is not empty. If it is not empty, processing of module 700 determines whether the status of the inter-layer dependency is a hazardous inter-layer dependency. If yes, the target layer is skipped (omitted from being pulled), in one example, else the target layer is pulled from the repository. In this example, the target layer (e.g., layer 8) is not skipped since it does not have a patch in error nor does it have a hazardous dependency. Therefore, processing continues to the next layer (e.g., layer 7), which is now the target layer. Based on the processing, in this example, layer 7 is skipped because of it hazardous dependency on layer 5 that has a patch in error (and thus, is also skipped). Processing continues for other image layers of the container.

In one example, to perform recovery on containers having one or more image layers with one or more errors (e.g., patches in error) and layers that have inter-layer dependencies, container layer recovery code (e.g., container layer recovery code 150) is used, in accordance with one or more aspects of the present disclosure. Container layer recovery code (e.g., container layer recovery code 150) includes code or instructions used to automatically recover containers that have patch in error layers with inter-layer dependencies, in accordance with one or more aspects of the present disclosure. The code is, e.g., computer-readable program code (e.g., instructions) in computer-readable media, e.g., storage (persistent storage 113, cache 121, storage 124, other storage, as examples). The computer-readable media may be part of a computer program product and the computer-readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the code and/or portions thereof. Further, different portions of code 150 may be in different storage and/or in the same storage. Many examples are possible.

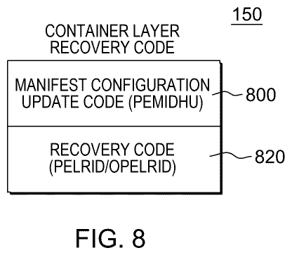

One example of container layer recovery code 150 is described with reference to FIG. 8. In one example, container layer recovery code 150 includes manifest configuration update code 800 (e.g., patch in error manifest inter-layer dependency healthy updater (PEMIDHU) module) to be used to obtain inter-layer dependencies between layers and to update a manifest configuration based on the dependency determination; and recovery code 820 (e.g., patch (or online patch) in error layer recovery on inter-layer dependency (PELRID/OPELRID)) to be used to recover the container having the layer with the patch in error and any inter-layer dependency layers. Additional, less and/or other code may be provided and/or used in one or more aspects of the present disclosure.

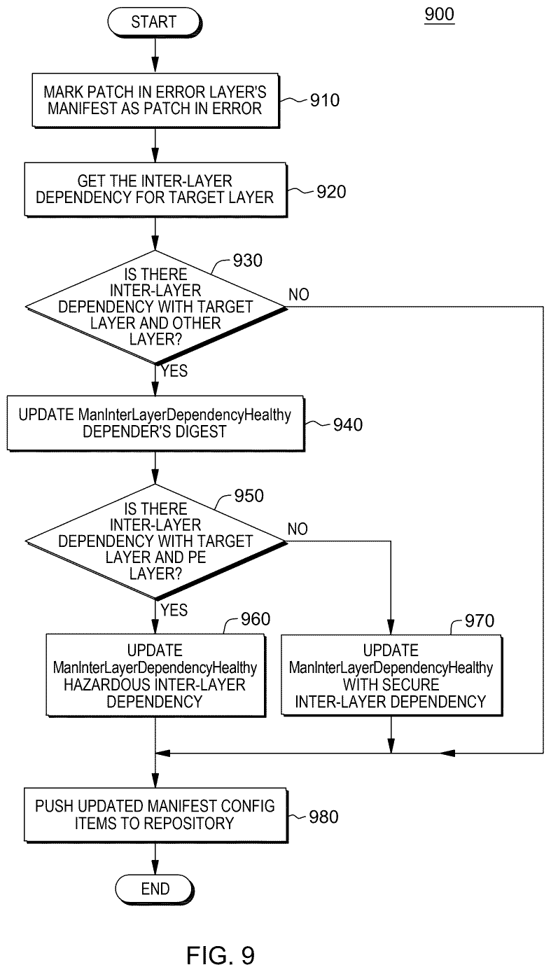

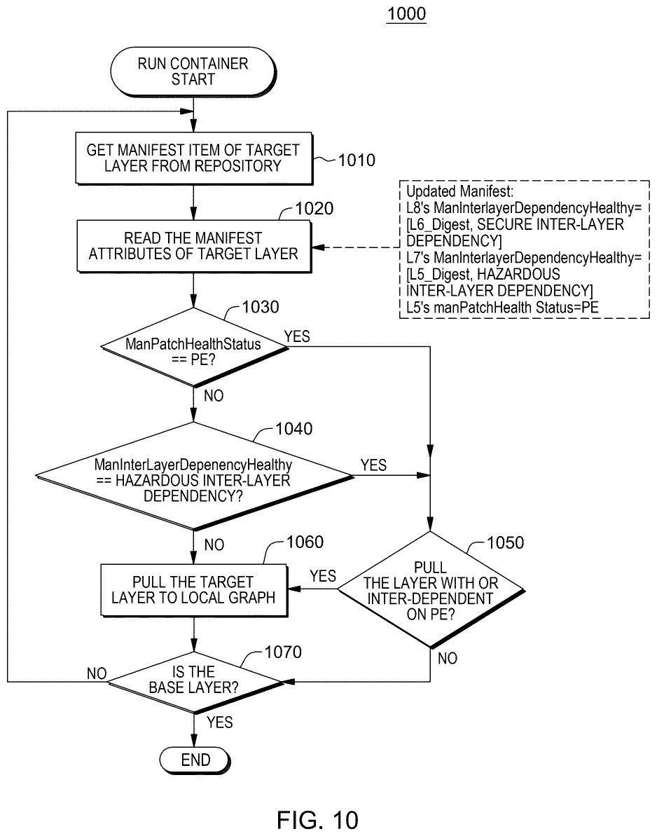

In one example, container layer recovery code 150 includes code (e.g., code 800-820) that is used to automatically perform recovery of containers having layers with patches in error and layers with inter-layer dependencies thereon, as further described in one example with reference to FIGS. 9-10. FIG. 9 depicts one example of a patch in error manifest inter-layer dependency healthy updater (PEMIDHU) process and FIG. 10 depicts one example of a patch (or online patch) in error layer recovery on inter-layer dependency (PELRID/OPELRID) process, each of which is executed by one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the process and/or portions thereof. Various options are possible.

Referring to FIG. 9, in one example, a patch in error manifest inter-layer dependency healthy updater process (PEMIDHU) 900 (also referred to herein as process 900) uses, e.g., manifest configuration update code 800 (e.g., patch in error manifest inter-layer dependency healthy updater module 426) to update the attributes of a layer's manifest configuration (e.g., ManInterLayerDependencyHealthy) and push the updated manifest configuration to the repository. In one example, process 900 is triggered by a container command, such as the set layer as patch in error with inter-layer dependency command. Other examples are possible.

In one example, based on obtaining (e.g., receiving, being provided, getting, pulling, etc.) the set layer command, process 900 marks 910 a manifest of the patch in error layer (e.g., L5 in this example) as a patch in error. Further, process 900 obtains 920 for a target layer (e.g., L8 in this example) any inter-layer dependencies on layers higher than the layer with the patch in error, as an example. The layer with the patch in error is L5, so the layers higher than that layer and lower than the target layer are layers L6 and L7, in this example. Process 900 determines 930 whether there is an inter-layer dependency between the target layer and one or more other layers. This may be determined, for instance, by checking dependency information or a graph that tracks dependencies. Further, it may be determined by checking whether image layers modify a common file. If so, they are inter-layer dependent. Other examples are possible. In this example, L8 has an inter-layer dependency on L6. If there is at least one inter-layer dependency between the target layer and another layer, process 900 updates 940 the manifest layer dependency healthy depender's digest (e.g., updates L6_Digest) in the manifest configuration item attribute, e.g., ManInterLayerDependencyHealthy for L8.

For instance, process 900 determines 950 whether there is an inter-layer dependency between the target layer (e.g., L8) and the patch in error layer (e.g., L5). If there is such a dependency, then process 900 updates 960 an attribute of the target layer, e.g., ManInterLayerDependencyHealthy hazardous inter-layer dependency to indicate the hazardous dependency. However, if there is no dependency between the target layer (e.g., L8) and the patch in error layer (e.g., L5), then process 900 updates 970 an attribute of the target layer, e.g., ManInterLayerDependencyHealthy with secure inter-layer dependency to indicate that layer L8 does not have a hazardous dependency on the layer with the patch in error (e.g., L5).

Thereafter, or if there are no inter-layer dependencies with the target layer and another layer, process 900 pushes 980 the updated manifest configuration items to the repository. This process is repeated for each target layer (e.g., each layer higher than the layer with the patch in error). For instance, the process is repeated for L7 as the target layer and then L6 as the target layer. Other examples are possible. Further, the pushing to the repository may be performed after processing of all the target layers (or a portion thereof).

Based on pushing the updated manifest after performing processing for the target layers, the updated manifest includes, for example: L5's ManPatchHealthStatus=patch in error; L7's ManInterLayerDepndencyHealthy=[L5_Digest, Hazardous inter-layer dependency]; and L8's ManInterLayerDependencyHealthy=[L6_Digest, Secure inter-layer dependency]. Other examples are possible.

Based on updating the manifest, a patch (or online patch) in error layer recovery on inter-layer dependency process 1000 (FIG. 10) (also referred to herein as process 1000) is executed, e.g., using recovery code 820 (e.g., patch in error layer recovery on inter-layer dependency module 434). In one example, the patch (or online patch) in error layer recovery on inter-layer dependency process is triggered by a command, such as a recovery layer on inter-layer dependency command, to recover the container having the layer with patch in error more precisely based on inter-layer dependencies by pulling only the layers not marked with patch in error or without hazardous inter-layer dependency on the layer with patch in error.

In one example, referring to FIG. 10, process 1000 obtains (e.g., gets, receives, is provided, pulls, etc.) 1010 a manifest item of the target layer from the repository, and reads 1020 the manifest attributes of the target layer. For instance, if the target layer is L8, its manifest item includes, e.g., L8's ManInterLayerDependencyHealthy=[L6_Digest, Secure inter-layer dependency]). In another example, if the target layer is L7, then its manifest item includes, e.g., L7's ManIntentLayerDepndencyHealthy=[L5_Digest, Hazardous inter-layer dependency].

Process 1000 determines 1030 whether the ManPatchHealthStatus for the target layer is a patch in error. If the target layer is not a patch in error, process 1000 determines 1040 whether an attribute for the target layer, e.g., ManInterLayerDependencyHealthy, is set to hazardous inter-layer dependency. If it is set to hazardous or if the target layer has the patch in error, process 1000 determines 1050 whether the layer with an inter-layer dependency on the patch in error or having the patch in error is to be pulled. In this example, a layer with the patch in error or an inter-layer dependency on the patch in error is to be omitted, and therefore, processing continues to inquiry 1070. However, if, in another example, the layer is to be pulled or if the ManInterLayerDependencyHealthy is not a hazardous inter-layer dependency, process 1000 pulls 1060 the target layer to the local graph, and processing continues to inquiry 1070. At inquiry 1070, process 1000 determines whether this is the base layer. If so, processing is complete; otherwise, processing continues to obtain 1010 the manifest item of the next target layer from the repository.

In one or more aspects, an intelligent capability is provided to recover containers with patches in error more precisely based on inter-layer dependencies to ensure better use of product capabilities, automation and resiliency insights. One or more aspects include, for instance: a manifest configuration attribute, e.g., ManInterLayerDependencyHealthy attribute, included in the manifest configuration item, including two status types: [Depender's Digest, Hazardous inter-layer dependency] to describe the dangerous inter-layer dependency between Dependee and Depender (e.g. the layer with patch in error), and [Depender's Digest, Secure inter-layer dependency] to describe the safe inter-layer dependency between Dependee and Depender; a command, set layer as patch in error with inter-layer dependency, to update the attributes of the layer's manifest configuration, e.g., ManInterLayerDependencyHealthy; a Patch in Error Manifest Inter-Layer Dependency Healthy Updater (PEMIDHU) module used by a container engine to update the attributes of the layer's manifest configuration ManInterLayerDependencyHealthy and push the updated manifest configuration to the repository; a command, recovery layer on inter-layer dependency, to recover the layer with the patch in error more precisely based on inter-layer dependencies; and/or a Patch (or Online Patch) in Error Layer Recovery on Dependency (OPELRD) module used by a graph driver to recover the layer with patch in error more precisely based on inter-layer dependencies by pulling only the layers not marked with patch in error or without a hazardous inter-layer dependency on the layer with patch in error. Other examples are possible.

One or more embodiments described herein improve the functioning of a computer by enhancing the management and recovery of containerized applications, particularly in handling patches in error when there are inter-layer dependencies. One or more improvements include, for instance:

Operational Continuity: By allowing the recovery of image layers with patches in error when there are inter-layer dependencies with the patch in error layer, allows users to recover the patches in error more precisely based on inter-layer dependencies. This minimizes downtime, which is beneficial for maintaining high availability and reliability in production environments.

Enhanced Security: By quickly identifying and addressing patches in error with inter-layer dependencies, one or more embodiments reduce the exposure to security vulnerabilities. This proactive approach ensures that the containerized applications are protected from potential threats and maintain their integrity, thereby enhancing the overall security posture of the computing environment.

Improved Automation and Resiliency: The intelligent and automatic technique for recovering layers with patches in error promotes better use of product capabilities and automation. It allows for real-time updates and adjustments to the containerized applications, improving their resiliency and adaptability to changing conditions and requirements.

Transparency and Ease of Use: One or more embodiments are transparent to both developers and end users, meaning that such embodiments do not require significant changes to existing workflows or additional manual interventions. The introduction of commands simplifies the process of managing patches in error, making it easier for users to maintain and update their containerized applications. Both developers and users can easily maintain and upgrade the whole environment without the need for extra work to consider about the negative impact of the patches in error.

Compatibility with Existing Tools: One or more embodiments are compatible with current container tools, including combinations and/or multiples thereof. This ensures that users can integrate one or more of the embodiments described herein into existing infrastructures without the need for extensive modifications or new toolsets, thereby simplifying the implementation process.

Overall, one or more embodiments improve the functioning of a computer by providing a robust, efficient, and secure approach for managing containerized applications executing within a computing environment, particularly in handling patches in error when there are inter-layer dependent layers. One or more aspects recover the layer with patch in error more precisely based on inter-layer dependencies to skip not only the layer with the patch in error but also the layer which has a hazardous inter-layer dependency on the layer with the patch in error.

The computing environments described herein are only examples of computing environments that can be used. One or more aspects of the present disclosure may be used with many types of environments. Each computing environment is capable of being configured to include and/or use one or more aspects of the present disclosure. For instance, each may be configured to provide container recovery and/or to perform one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, many containerization processes may be used. Further, other commands and/or attributes may be used. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
identifying an image layer of a container image deployed as a container on a local resource as having a patch in error;
marking, at an image repository, the image layer as having the patch in error;
determining that one or more image layers of the container have a dependency on the image layer having the patch in error;
indicating, at the image repository, that the one or more image layers have the dependency on the image layer having the patch in error; and
initiating recovery of the container, the recovery of the container being based on at least one of the marking or the indicating, wherein to recover the container selected image layers are to be pulled from the image repository, wherein the image layer marked as having the patch in error and the one or more image layers indicated as having the dependency on the image layer having the patch in error are to be omitted from being pulled.

2. The method of claim 1, wherein the marking includes modifying one or more attributes of a manifest configuration for the image layer having the patch in error to indicate that the image layer has the patch in error.

3. The method of claim 1, wherein the indicating includes modifying at least one attribute of one or more attributes of a manifest configuration for the one or more image layers having the dependency on the image layer having the patch in error to indicate one or more inter-layer dependencies.

4. The method of claim 3, wherein the one or more attributes include a manifest inter-layer dependency healthy attribute that includes a hazardous status type and a secure status type, and wherein the hazardous status type is used to indicate that the one or more image layers have the dependency on the image layer having the patch in error.

5. The method of claim 4, wherein the one or more image layers that are indicated with the hazardous status type are omitted from being pulled.

6. The method of claim 1, wherein at least one of the marking or the indicating is performed based on a command used to invoke a module to perform the at least one of the marking or the indicating.

7. The method of claim 1, wherein the indicating includes using an updater module to update one or more attributes of a manifest configuration for the one or more image layers having the dependency to provide at least one updated attribute and to push the at least one updated attribute to the image repository.

8. The method of claim 7, wherein the updater module executes on a recovery engine coupled to the image repository.

9. The method of claim 1, wherein the initiating recovery of the container is based on a command used to initiate recovery of the container.

10. The method of claim 1, wherein the recovery of the container is to use a recovery module to recover the container, the recovery module to be executed on a driver coupled to the local resource.

11. A computer program product comprising:
a set of one or more computer-readable storage media; and
program instructions, collectively stored in the set of one or more computer-readable storage media, for causing at least one computing device to perform computer operations including:
identifying an image layer of a container image deployed as a container on a local resource as having a patch in error;
marking, at an image repository, the image layer as having the patch in error;
determining that one or more image layers of the container have a dependency on the image layer having the patch in error;
indicating, at the image repository, that the one or more image layers have the dependency on the image layer having the patch in error; and
initiating recovery of the container, the recovery of the container being based on at least one of the marking or the indicating, wherein to recover the container selected image layers are to be pulled from the image repository, wherein the image layer marked as having the patch in error and the one or more image layers indicated as having the dependency on the image layer having the patch in error are to be omitted from being pulled.

12. The computer program product of claim 11, wherein the marking includes modifying one or more attributes of a manifest configuration for the image layer having the patch in error to indicate that the image layer has the patch in error.

13. The computer program product of claim 11, wherein the indicating includes modifying at least one attribute of one or more attributes of a manifest configuration for the one or more image layers having the dependency on the image layer having the patch in error to indicate one or more inter-layer dependencies.

14. The computer program product of claim 13, wherein the one or more attributes include a manifest inter-layer dependency healthy attribute that includes a hazardous status type and a secure status type, and wherein the hazardous status type is used to indicate that the one or more image layers have the dependency on the image layer having the patch in error.

15. The computer program product of claim 11, wherein the indicating includes using an updater module to update one or more attributes of a manifest configuration for the one or more image layers having the dependency to provide at least one updated attribute and to push the at least one updated attribute to the image repository.

16. A computer system comprising:
at least one computing device;
a set of one or more computer-readable storage media; and
program instructions, collectively stored in the set of one or more computer-readable storage media, for causing the at least one computing device to perform computer operations including:
identifying an image layer of a container image deployed as a container on a local resource as having a patch in error;
marking, at an image repository, the image layer as having the patch in error;
determining that one or more image layers of the container have a dependency on the image layer having the patch in error;
indicating, at the image repository, that the one or more image layers have the dependency on the image layer having the patch in error; and
initiating recovery of the container, the recovery of the container being based on at least one of the marking or the indicating, wherein to recover the container selected image layers are to be pulled from the image repository, wherein the image layer marked as having the patch in error and the one or more image layers indicated as having the dependency on the image layer having the patch in error are to be omitted from being pulled.

17. The computer system of claim 16, wherein the marking includes modifying one or more attributes of a manifest configuration for the image layer having the patch in error to indicate that the image layer has the patch in error.

18. The computer system of claim 16, wherein the indicating includes modifying at least one attribute of one or more attributes of a manifest configuration for the one or more image layers having the dependency on the image layer having the patch in error to indicate one or more inter-layer dependencies.

19. The computer system of claim 18, wherein the one or more attributes include a manifest inter-layer dependency healthy attribute that includes a hazardous status type and a secure status type, and wherein the hazardous status type is used to indicate that the one or more image layers have the dependency on the image layer having the patch in error.

20. The computer system of claim 16, wherein the indicating includes using an updater module to update one or more attributes of a manifest configuration for the one or more image layers having the dependency to provide at least one updated attribute and to push the at least one updated attribute to the image repository.
